(19) United States
(12) Patent Application Publication
(10) Pub. No.: US 2020/0187710 A1
(43) Pub. Date: Jun. 18, 2020

(54) SMOKELESS OVEN WITH SMOKING FUNCTION

(71) Applicant: GUANGDONG XINBAO ELECTRICAL APPLIANCES HOLDINGS CO., LTD., Foshan (CN)

(72) Inventors: Jiangang GUO, Foshan (CN); Li CHEN, Foshan (CN)

(21) Appl. No.: 16/579,835

(22) Filed: Sep. 24, 2019

(30) Foreign Application Priority Data
Dec. 18, 2018 (CN) 201822133026.X
Mar. 1, 2019 (CN) 201920261718.4
Mar. 1, 2019 (CN) 201920262039.9

(51) Int. Cl. A47J 37/06; A23B 4/052

(52) U.S. Cl. CPC A47J 37/0623; A23B 4/052

(57) ABSTRACT

The present invention relates to the technical field of ovens, and more particularly, to a smokeless oven with a smoking function, which comprises an oven body, wherein a smoking box is arranged in the oven body; the body walls of the oven body are provided with an air-introducing assembly and a smoke-exhausting assembly; both the air-introducing assembly and the smoke-exhausting assembly are communicated with the exterior and interior of the oven body; a filter is arranged in the smoke-exhausting assembly; according to the present invention, the air-introducing assembly provides fresh air to the smoking box and controls the supply of the air; the smoke to be exhausted is filtered through the smoke-exhausting assembly; the process of producing smoke can be controlled, the smoke can be prevented from being directly exhausted to the environment, and a safe and eco-friendly use can be achieved.

### TECHNICAL FIELD OF THE INVENTION

The present invention relates to the technical field of ovens, and more particularly, to a smokeless oven with a smoking function.

### BACKGROUND OF THE INVENTION

With the improvement of people's living standards, ovens for processing food are common in millions of households worldwide. In the prior art, traditional ovens for processing food are normally single-functioned, allowing food to be baked only. However, some food not only needs to be baked but also needs to be smoked so that the real deliciousness of the food can be released, and to provide extra flavor. Chinese patent CN204889716U discloses a smoke oven, comprising an oven body and an oven door, wherein a chamber is formed in the oven body, and a smoking device and a temperature-control device are arranged in the chamber. The smoking device is heated through the temperature-control device, thus producing smoke for smoking food. It makes the oven multifunctional and more convenient to use. However, as the smoking device is controlled through the temperature-control device, the heating temperature can be controlled, but the mixing degree between the smoking device and the air cannot be controlled. As a result, it's difficult to control the production of smoke. Even worse, an open flame can be easily caused, which is dangerous. Moreover, the smoke and fume generated during the process can seriously pollute the environment. Thus, it's urgent for those skilled in the art to develop a novel oven with smoking function.

### SUMMARY OF THE INVENTION

The purpose of the present invention is to solve the shortcomings in the prior art by providing a smokeless oven with a smoking function, which controls the production of smoke while preventing the smoke from being directly exhausted to the environment, achieving a safe and eco-friendly use.

To achieve the above purpose, the present invention adopts the following technical solution:

A smokeless oven with a smoking function, comprising an oven body, wherein a smoking box is arranged in the oven body; the body walls of the oven body are provided with an air-introducing assembly and a smoke-exhausting assembly; both the air-introducing assembly and the smoke-exhausting assembly are communicated with the exterior and interior of the oven body; a filter is arranged in the smoke-exhausting assembly; according to the present invention, the air-introducing assembly provides fresh air to the smoking box and controls the supply of the air; the smoke to be exhausted is filtered through the smoke-exhausting assembly; the process of producing smoke can be controlled, the smoke can be prevented from being directly exhausted to the environment, and a safe and eco-friendly use can be achieved.

In another aspect of the present invention, the smoking box is located on the bottom surface of the interior of the oven body, and the air-introducing assembly and the smoke-exhausting assembly are respectively arranged on opposite side walls of the oven body. The smoking box is arranged at the bottom of the oven body, allowing the smoke produced by the smoking box to thoroughly smoke the food in the oven body during its rising process. The smoking effect of the food can be improved. The air-introducing assembly and the smoke-exhausting assembly are respectively arranged on opposite side walls of the oven body, thereby introducing the air from one side of the oven body while exhausting the smoke from the other side of the oven body. The circulation of the air and the smoke in the oven body can be accelerated, further improving the food's smoking efficiency and the smoke-exhausting efficiency.

In another aspect of the present invention, the smoking box comprises a box body and a box cover, and the box cover is detachably connected to the box body through a rotary buckle structure. Through the interaction between the box body and the box cover, the smoking box can be conveniently opened for replacing the fuel.

In another aspect of the present invention, the air-introducing assembly comprises an air-introducing plate, an air guide cover and an air-introducing fan. An air inlet is formed in the air-introducing plate, and the air-introducing plate is fixedly arranged on the outer side surface of the oven body. The air inlet is communicated with an opening in the oven body. The air guide cover and the air-introducing fan are respectively arranged on the air-introducing plate, and the air-in end of the air guide cover is connected to an outlet of the air-introducing fan. The air-out end of the air guide cover covers the air inlet of the air-introducing plate. The external fresh air is introduced in through the air-introducing fan, and then guided into the oven body through the air guide cover. Thus, the air-introducing assembly can provide fresh air for the smoking box, thus keeping the half-combustion state of the fuel in the smoking box. In this way, more smoke can be produced so that the smoking efficiency can be improved.

In another aspect of the present invention, the air guide cover is internally provided with an air shield for sealing or opening the air-in end of the air guide cover. One side of the air shield is rotatably connected to the air guide cover through a rotating shaft, thereby enabling the other side of the air shield to be turned over. When the air-introducing assembly no longer needs to supply fresh air to the oven body, the interior of the air-introducing assembly can be sealed by the air shield. In this way, the leakage of the smoke in the oven body can be avoided, protecting the environment from being polluted. Meanwhile, as the smoke can be completely used for cooking, the waste of smoke caused by the leakage can be avoided.

In another aspect of the present invention, the smoke-exhausting assembly comprises a lower smoke-exhausting pipe and an upper smoke-exhausting pipe. The lower smoke-exhausting pipe and the upper smoke-exhausting pipe are respectively connected with the two sides of the filter. The lower smoke-exhausting pipe is communicated with the opening in the side wall of the oven body. The smoke in the oven body is guided to the filter through the lower smoke-exhausting pipe, and then exhausted to the outside through the upper smoke-exhausting pipe after being filtered by the filter. Thus, the smoke can be purified before being exhausted, improving the smoke-exhausting efficiency, and avoiding the pollution to the environment.

In another aspect of the present invention, a smoke-exhausting fan is arranged in the upper smoke-exhausting pipe, and the smoke in the oven body can be sucked out by the smoke-exhausting fan, greatly increasing and the smoke-exhausting speed.

In another aspect of the present invention, a sealing plate is arranged between the lower smoke-exhausting pipe and the filter, and a propelling device is connected to the sealing plate. The propelling device is used for propelling the sealing plate to reciprocate, thereby sealing or opening the passage between the lower smoke-exhausting pipe and the filter. Through being propelled by the propelling device, the sealing plate can open or seal the entrance of the filter. When the smoke does not need to be exhausted, the sealing plate can be closed. At this point, the oven body is full of smoke so that the food can be sufficiently smoked, and the smoking efficiency can be improved. When the smoke needs to be exhausted, the sealing plate can be opened, allowing the smoke to be exhausted. Thus, the exhausting speed of the smoke can be increased.

In another aspect of the present invention, the filter comprises a filter box, a filter element and a cover. One side of the filter box is provided with an opening. The cover is rotatably connected to one side of the filter box provided with the opening in a rotatable opening and closing manner through a rotating shaft. The filter element can be freely inserted into or pulled out of the filter box from the opening of the filter box. The filter adopts an assembled structure, allowing the filter element to be conveniently replaced. Thus, an ideal filtering effect of the filter element can be achieved.

In another aspect of the present invention, the two sides of the filter box are respectively provided with an upper connecting hole and a lower connecting hole. The upper connecting hole is connected to the upper smoke-exhausting pipe, and the lower connecting hole is connected to the lower smoke-exhausting pipe. Through adopting the aforesaid structure, the smoke-exhausting pipes located at the two ends are connected to the filter box through the connecting holes, making the connection firmer, and preventing the smoke-exhausting pipes from falling off. As an ideal sealing effect can be achieved, the leakage of the smoke can be avoided.

In another aspect of the present invention, the two sides of the filter element are respectively provided with an upper air hole and a lower air hole. The upper air hole corresponds to the upper connecting hole, and the lower air hole corresponds to the lower connecting hole. The periphery of the upper air hole and the periphery of the lower air hole are respectively provided with a sealing ring. The sealing rings on the peripheries of the upper air hole and the lower air hole are respectively clamped with the inner wall surfaces of the upper connecting hole and the lower connecting hole. Through making the connecting holes in the filter box respectively correspond to the air holes and in the filter element, and making the sealing rings on the two sides of the filter element respectively clamped in the upper connecting hole and the lower connecting hole, the filter element can be positioned in the filter box and can be prevented from shaking, allowing the smoke to directly pass through the filter element through the connecting holes and the air holes. Thus, the filtering effect can be greatly improved.

In another aspect of the present invention, the cover comprises a pressing plate and a covering plate. The pressing plate is fixedly mounted on one side of the opening of the filter box, and the pressing plate surrounds the periphery of the opening of the filter box. The covering plate is connected to the filter box in a rotatable opening and closing manner through a rotating shaft. The pressing plate and the filter box form a space for allowing the filter element to be conveniently installed in, and the side opening of the filter box is closed through the interaction between the covering plate and the pressing plate. Moreover, the covering plate can be opened, allowing the filter element to be conveniently taken out while ensuring the sealing effect after the covering plate is closed.

In another aspect of the present invention, an elastic locker is arranged on the pressing plate, and a locking hook is arranged on the covering plate. The locking hook interacts with the elastic locker, thereby enabling the covering plate and the pressing plate to be locked or unlocked. Through the interaction between the elastic locker and the locking hook, the connection between the covering plate and the pressing plate can be more stable, and the covering plate can be conveniently opened.

In another aspect of the present invention, a sealing element and a driving element are arranged in the lower smoke-exhausting pipe. The driving element is used for driving the sealing element to move, thus enabling the sealing element to open or close the opening communicated with the lower smoke-exhausting pipe in the side wall of the oven body. Through driving the sealing element to move by the driving element, the smoke-exhausting passage between the lower smoke-exhausting pipe and the oven body can be automatically closed or opened, allowing the oven body and the smoke-exhausting passage to be selectively kept in a communicated or isolated state according to use requirements. Thus, a secondary pollution to the food can be avoided.

In another aspect of the present invention, a plurality of exhausting holes distributed in a circumferential array are formed in the side wall of the oven body, and the exhausting holes are communicated with the lower smoke-exhausting pipe. The sealing element comprises a plurality of sealing blades arranged in a circumferential array. The driving element comprises a driving rod and a driver, and the driving rod is rotatably arranged on the oven body. The sealing element is fixed on the driving rod and is attached to the exhausting holes. The driver is used for driving the driving rod to rotate, thereby enabling the sealing blades to rotate relative to the exhausting holes. Thus, the positions of the sealing blades and the exhausting holes can be staggered or overlapped, allowing the exhausting holes to be opened or closed by the sealing blades. Through the one-to-one interaction between the plurality of sealing blades distributed in a circumferential array and the plurality of exhausting holes arranged in a circumferential array, the exhausting efficiency can be improved in the opening state. When the exhausting holes need to be sealed, the sealing element can be rotated by an angle and the exhausting holes can be sealed. The structure of the sealing valve is simple and reliable, achieving a better sealing effect.

In another aspect of the present invention, one end of the driving rod is rotatably arranged on the oven body, and the other end of the driving rod is rotatably arranged on the lower smoke-exhausting pipe. A sealing ring is arranged at the position where the driving rod is in contact with the lower smoke-exhausting pipe. The two ends of the driving rod are installed by adopting a rotatable structure. Meanwhile, by means of the sealing ring arranged on the driving rod, the rotatable structure of the driving rod can be more stable, achieving a better sealing effect between the driving rod and the smoke-exhausting pipes. Thus, the smoke can be prevented from being leaked.

In another aspect of the present invention, an elastic element is arranged between the driving rod and the sealing element, and the elastic element is used for pressing the sealing element on the exhausting holes. Through the elastic force imposed on the sealing element by the elastic element, the sealing element 46 can be tightly attached to the exhausting holes. In this way, the exhausting holes can be better sealed by the sealing element.

In another aspect of the present invention, a plurality of linearly-distributed exhausting holes are formed in the side wall of the oven body, and a plurality of linearly-distributed sealing blades are arranged on the sealing element. The driving element is used for driving the sealing element to linearly reciprocate, enabling the sealing element to reciprocate between the staggered position and the overlapped position. Thus, the opening and closing of the exhausting holes can be achieved. Through the one-to-one interaction between the plurality of linearly-distributed sealing blades of the sealing element and the plurality of linearly-distributed exhausting holes, the exhausting efficiency can be improved in the opening state. When the exhausting holes need to be sealed, the sealing element can be moved for a small distance and the exhausting holes can be sealed. The structure of the sealing valve is simple and reliable, achieving a better sealing effect.

In another aspect of the present invention, a stopping block is arranged on the driving element, and a touch switch is arranged at the position corresponding to the stopping block. The touch switch is connected to the driving element for controlling the reversing of the driving element. Through the interaction between the stopping block on the driving element and the touch switch, the driving element can be automatically reversed. Thus, when being driven, the moving direction of the sealing element is more accurate, and a correct state-switching of the sealing element can be ensured.

Compared with the prior art, the present invention has the following advantages:

The smokeless oven with a smoking function of the present invention is connected to the air-introducing assembly. The air-introducing assembly can supply oxygenated air to the smoking box and can control the flow of supplied air. Thus, the fuel in the smoking box is always kept in a half-combustion state, thus preventing the fuel from being extinguished. In this way, an open flame can be avoided, and more smoke can be produced, improving the food's smoking effect and increasing the cooking speed while ensuring the use safety. Moreover, the oven body is connected to the smoke-exhausting assembly, and the filter is arranged in the smoke-exhausting assembly. According to this design, after the food is smoked by the smoke produced in the oven body, the smoke can be filtered by the filter, and then exhausted to the outside, reducing the environmental pollution caused by the smoke. Thus, the environment can be protected.

### BRIEF DESCRIPTION OF THE DRAWINGS

FIG. 1 is a structural diagram of the present invention;

FIG. 2 is a structural diagram of the present invention from another viewing angle;

FIG. 3 is a structural diagram of the smoking box of the present invention;

FIG. 4 is a structural diagram of the air-introducing assembly of the present invention;

FIG. 5 is a structural diagram of the smoke-exhausting assembly of the present invention;

FIG. 6 is an explosive view of the smoke-exhausting assembly of the present invention;

FIG. 7 is a first structural diagram of the sealing element of the present invention;

FIG. 8 is the structural diagram of the sealing element and the driving element;

FIG. 9 is another structural diagram of the sealing element and the driving element;

FIG. 10 is a second structural diagram of the sealing element of the present invention.

In the Figures:

10—Oven Body, 20—Smoking Box, 30—Air-introducing Assembly, 40—Smoke-exhausting Assembly, 11—Exhausting Hole, 21—Box Body, 22—Box Cover, 31—Air-introducing Plate, 32—Air Guide Cover, 33—Air-introducing Fan, 31—Air Shield, 41—Lower Smoke-exhausting Pipe, 42—Upper Smoke-exhausting Pipe, 43—Air-exhausting Fan, 44—Sealing Plate, 45—Propelling Device, 46—Sealing Element, 47—Driving Element, 471—Driving Rod, 472—Driving Device, 473—Elastic Element, 474—Stopping Block, 51—Filter Box, 52—Filter Element, 53—Cover, 54—Upper Connecting Hole, 55—Lower Connecting Hole, 56—Upper Air Hole, 57—Lower Air Hole, 58—Sealing Ring, 531—Pressing Plate, 532—Covering Plate, 533—Locker, 534—Locking Hook.

### DETAILED DESCRIPTION OF THE INVENTION

Drawings and detailed embodiments are combined hereinafter to elaborate the technical principles of the present invention.

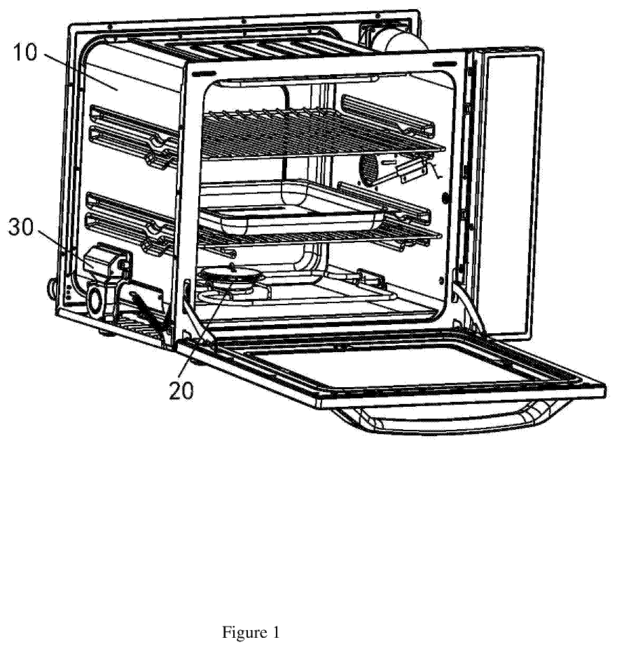

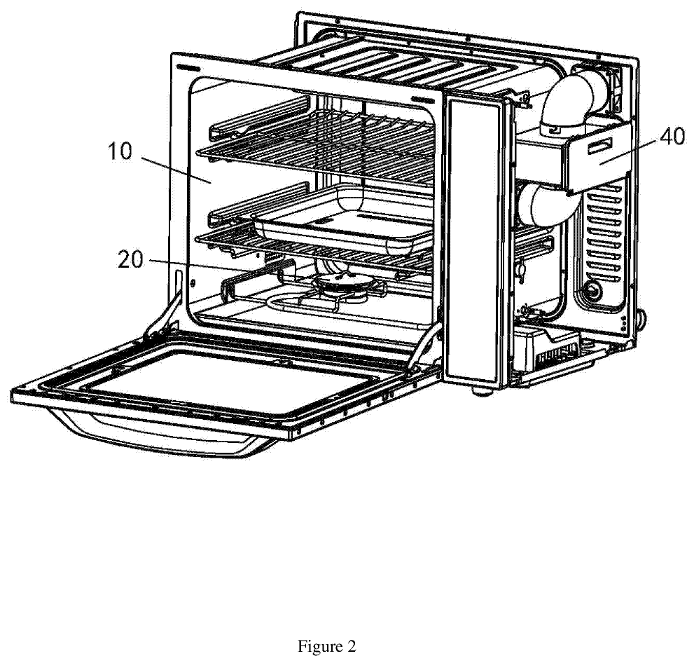

As shown in FIGS. 1 and 2, the smokeless oven with a smoking function of the present invention comprises an oven body 10, wherein a smoking box 20 is arranged in the oven body 10. An air-introducing assembly 30 is arranged on a body wall of the oven body 10, and a smoke-exhausting assembly 40 is arranged on a body wall of the oven body 10. Both the air-introducing assembly 30 and the smoke-exhausting assembly 40 are communicated with the exterior and the interior of the oven body 10. The outlet of the air-introducing assembly 30 is close to the smoking box 20, and a filter 50 is arranged in the smoke-exhausting assembly 40. It should be noted that the body walls of the oven comprise side walls, a top wall and a bottom wall. The smokeless oven with a smoking function of the present invention is connected to the air-introducing assembly 30. The air-introducing assembly 30 can supply oxygenated air to the smoking box 20 and can control the flow of supplied air. Thus, the fuel in the smoking box 20 is always kept in a half-combustion state, thus preventing the fuel from being extinguished. In this way, an open flame can be avoided, and more smoke can be produced, improving the food's smoking effect and increasing the cooking speed while ensuring the use safety. Moreover, the oven body 10 is connected to the smoke-exhausting assembly 40, and the filter 50 is arranged in the smoke-exhausting assembly 40. According to this design, after the food is smoked by the smoke produced in the oven body 10, the smoke can be filtered by the filter 50, and then exhausted to the outside, reducing the environmental pollution caused by the smoke. Thus, the environment can be protected.

As shown in FIGS. 1 and 2, the smoking box 20 is located on the bottom surface of the interior of the oven body 10, and the air-introducing assembly 30 and the smoke-exhausting assembly 40 are respectively arranged on opposite side walls of the oven body 10. The smoking box 20 is arranged at the bottom of the oven body 10, allowing the smoke produced by the smoking box 20 to thoroughly smoke the food in the oven body 10 during its rising process. Thus, the smoking effect of the food can be improved. Furthermore, the air-introducing assembly 30 and the smoke-exhausting assembly 40 are respectively arranged on opposite side walls of the oven body 10, thereby introducing the air from one side of the oven body 10 while exhausting the smoke from the other side of the oven body 10. Thus, the circulation of the air and the smoke in the oven body 10 can be accelerated, further improving the food's smoking efficiency and the smoke-exhausting efficiency.

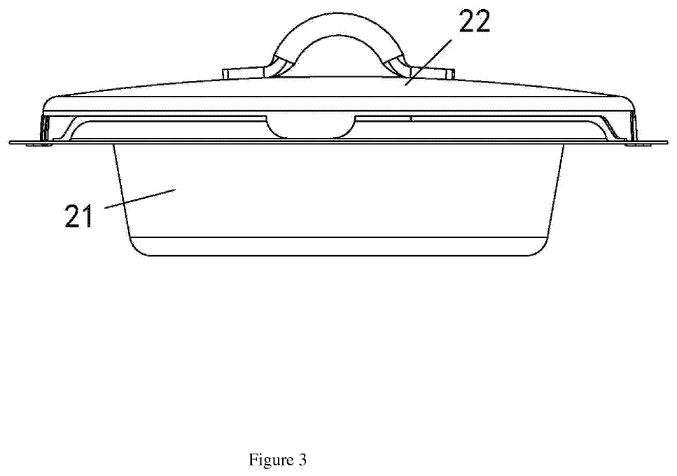

As shown in FIG. 3, the smoking box 20 comprises a box body 21 and a box cover 22, and the box cover 22 is detachably connected to the box body 21 through a rotary buckle structure. Through the interaction between the box body 21 and the box cover 22, the smoking box 20 can be conveniently opened for replacing the fuel.

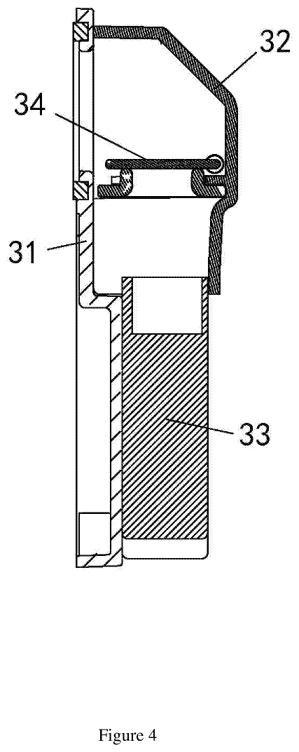

As shown in FIG. 4, the air-introducing assembly 30 comprises an air-introducing plate 31, an air guide cover 32 and an air-introducing fan 33. An air inlet is formed in the air-introducing plate 31, and the air-introducing plate 31 is fixedly arranged on the outer side surface of the oven body 10. The air inlet is communicated with an opening in the oven body 10. The air guide cover 32 and the air-introducing fan 33 are respectively arranged on the air-introducing plate 31, and the air-in end of the air guide cover 32 is connected to an outlet of the air-introducing fan 33. The air-out end of the air guide cover 32 covers the air inlet of the air-introducing plate 31. The external fresh air is introduced in through the air-introducing fan 33, and then guided into the oven body 10 through the air guide cover 32. Thus, the air-introducing assembly 30 can provide fresh air for the smoking box 20, thus keeping the half-combustion state of the fuel in the smoking box 20. In this way, more smoke can be produced so that the smoking efficiency can be improved. Meanwhile, the air guide cover 32 is internally provided with an air shield 34 for sealing or opening the air-in end of the air guide cover 32. One side of the air shield 34 is rotatably connected to the air guide cover 32 through a rotating shaft, thereby enabling the other side of the air shield 34 to be turned over. When the air-introducing assembly 30 no longer needs to supply fresh air to the oven body 10, the interior of the air-introducing assembly 30 can be sealed by the air shield 34. In this way, the leakage of the smoke in the oven body 10 can be avoided, protecting the environment from being polluted. Meanwhile, as the smoke can be completely used for cooking, the waste of smoke can be avoided.

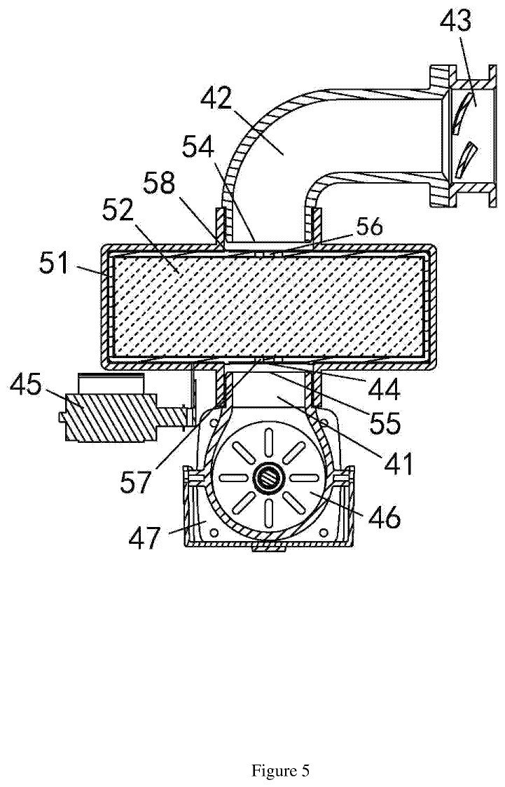

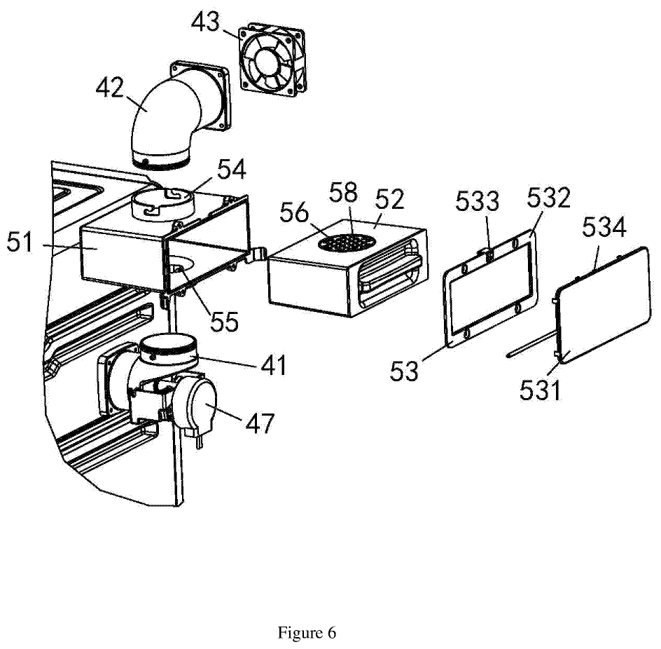

As shown in FIGS. 5 and 6, the smoke-exhausting assembly 40 comprises a lower smoke-exhausting pipe 41 and an upper smoke-exhausting pipe 42. The lower smoke-exhausting pipe 41 and the upper smoke-exhausting pipe 42 are respectively connected with the two sides of the filter 50. The lower smoke-exhausting pipe 41 is communicated with the opening in the side wall of the oven body 10. The smoke in the oven body 10 is guided to the filter 50 through the lower smoke-exhausting pipe 41, and then exhausted to the outside through the upper smoke-exhausting pipe 42 after being filtered by the filter 50. Thus, the smoke can be purified before being exhausted, improving the smoke-exhausting efficiency, and avoiding the pollution to the environment. Meanwhile, a smoke-exhausting fan 43 is arranged in the upper smoke-exhausting pipe 42, and the smoke in the oven body 10 can be sucked out by the smoke-exhausting fan 43, greatly increasing and the smoke-exhausting speed. Further, a sealing plate 44 is arranged between the lower smoke-exhausting pipe 41 and the filter 50, and a propelling device 45 is connected to the sealing plate 44. The propelling device 44 is used for propelling the sealing plate 44 to reciprocate, thereby sealing or opening the passage between the lower smoke-exhausting pipe 41 and the filter 50. Through being propelled by the propelling device 45, the sealing plate 44 can open or seal the entrance of the filter 50. When the smoke does not need to be exhausted, the sealing plate 44 can be closed. At this point, the oven body 10 is full of smoke so that the food can be sufficiently smoked, and the smoking efficiency can be improved. When the smoke needs to be exhausted, the sealing plate 44 can be opened, allowing the smoke to be exhausted. Thus, the exhausting speed of the smoke can be increased.

As shown in FIG. 6, the filter 50 comprises a filter box 51, a filter element 52 and a cover 53. One side of the filter box 51 is provided with an opening. The cover 53 is rotatably connected to one side of the filter box 51 provided with the opening in a rotatable opening and closing manner through a rotating shaft. The filter element 52 can be freely inserted into or pulled out of the filter box 51 from the opening of the filter box 51. The filter 50 adopts an assembled structure, allowing the filter element 52 to be conveniently replaced. Thus, an ideal filtering effect of the filter element can be achieved.

As shown in FIG. 6, the two sides of the filter box 51 are respectively provided with an upper connecting hole 54 and a lower connecting hole 55. The upper connecting hole 54 is connected to the upper smoke-exhausting pipe 42, and the lower connecting hole 55 is connected to the lower smoke-exhausting pipe 41. Through adopting the aforesaid structure, the smoke-exhausting pipes located at the two ends are connected to the filter box 51 through the connecting holes, making the connection firmer, and preventing the smoke-exhausting pipes from falling off. As an ideal sealing effect can be achieved, the leakage of the smoke can be avoided. Further, the two sides of the filter element 52 are respectively provided with an upper air hole 56 and a lower air hole 57. The upper air hole 56 corresponds to the upper connecting hole 54, and the lower air hole 57 corresponds to the lower connecting hole 55. The periphery of the upper air hole 56 and the periphery of the lower air hole 57 are respectively provided with a sealing ring 58. The sealing rings 58 on the peripheries of the upper air hole 56 and the lower air hole 57 are respectively clamped with the inner wall surfaces of the upper connecting hole 54 and the lower connecting hole 55. Through making the connecting holes in the filter box 51 respectively correspond to the air holes 56 and 57 in the filter element 52, and making the sealing rings 58 on the two sides of the filter element 52 respectively clamped in the upper connecting hole 54 and the lower connecting hole 55, the filter element 52 can be positioned in the filter box 51 and can be prevented from shaking, allowing the smoke to directly pass through the filter element 52 through the connecting holes and the air holes. Thus, the filtering effect can be greatly improved.

As shown in FIG. 6, the cover 53 comprises a pressing plate 531 and a covering plate 532. The pressing plate 531 is fixedly mounted on one side of the opening of the filter box 51, and the pressing plate 531 surrounds the periphery of the opening of the filter box 51. The covering plate 532 is connected to the filter box 51 in a rotatable opening and closing manner through a rotating shaft. The pressing plate 531 and the filter box 51 form a space for allowing the filter element 52 to be conveniently installed in, and the side opening of the filter box 51 is closed through the interaction between the covering plate 532 and the pressing plate 531. Moreover, the covering plate 532 can be opened, allowing the filter element 52 to be conveniently taken out while ensuring the sealing effect after the covering plate 532 is closed. Further, an elastic locker 533 is arranged on the pressing plate 531, and a locking hook 534 is arranged on the covering plate 532. The locking hook 534 interacts with the elastic locker 533, thereby enabling the covering plate 532 and the pressing plate 531 to be locked or unlocked. Through the interaction between the elastic locker 533 and the locking hook 534, the connection between the covering plate 532 and the pressing plate 531 can be more stable, and the covering plate 532 can be conveniently opened.

As shown in FIG. 6, a sealing element 46 and a driving element 47 are arranged in the lower smoke-exhausting pipe 41. The driving element 47 is used for driving the sealing element 46 to move, thus enabling the sealing element 46 to open or close the opening communicated with the lower smoke-exhausting pipe 41 in the side wall of the oven body 10. Through driving the sealing element 46 to move by the driving element 47, the smoke-exhausting passage between the lower smoke-exhausting pipe 41 and the oven body 10 can be automatically closed or opened, allowing the oven body 10 and the smoke-exhausting passage to be selectively kept in a communicated or isolated state according to use requirements. Thus, a secondary pollution to the food can be avoided.

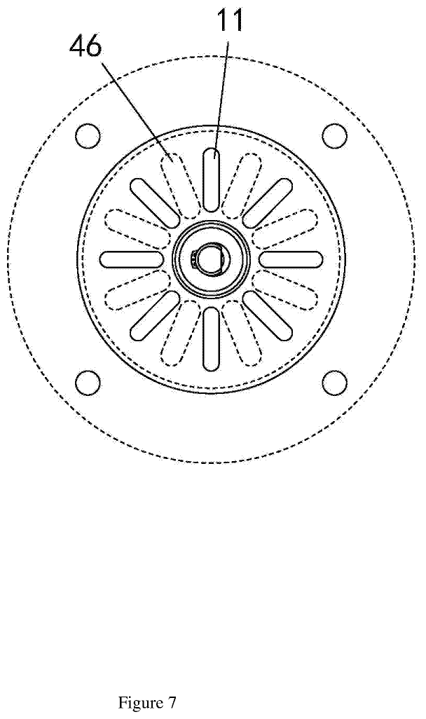

As shown in FIGS. 7, 8 and 9, a plurality of exhausting holes 11 distributed in a circumferential array are formed in the side wall of the oven body 10, and the exhausting holes 11 are communicated with the lower smoke-exhausting pipe 41. The aforesaid is the first structure for achieving the interaction between the sealing element 46 and the exhausting holes 11. The sealing element 46 comprises a plurality of sealing blades arranged in a circumferential array. The driving element 47 comprises a driving rod 471 and a driver 472, and the driving rod 471 is rotatably arranged on the oven body 10. The sealing element 46 is fixed on the driving rod 471 and is attached to the exhausting holes 11. The driver 472 is used for driving the driving rod 471 to rotate, thereby enabling the sealing blades to rotate relative to the exhausting holes 11. Thus, the positions of the sealing blades and the exhausting holes 11 can be staggered or overlapped, allowing the exhausting holes 11 to be opened or closed by the sealing blades. Through the one-to-one interaction between the plurality of sealing blades 46 distributed in a circumferential array and the plurality of exhausting holes 11 arranged in a circumferential array, under the driving of the driving element 47, the positions of the sealing blades can be switched during the rotating process. When the positions of the sealing blades and the exhausting holes 11 are staggered, the exhausting holes 11 are opened, and when the positions of the sealing blades and the exhausting holes 11 are overlapped, the exhausting holes 11 are blocked by the sealing blades. The exhausting efficiency can be improved in the opening state. When the exhausting holes need to be sealed, the sealing element 46 can be rotated by an angle and the exhausting holes can be sealed. The structure of the sealing valve is simple and reliable, achieving a better sealing effect.

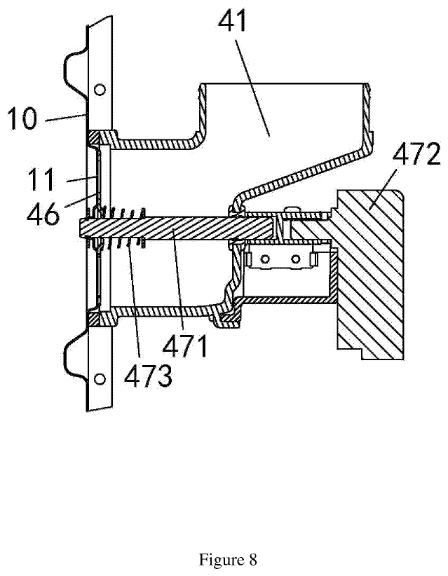

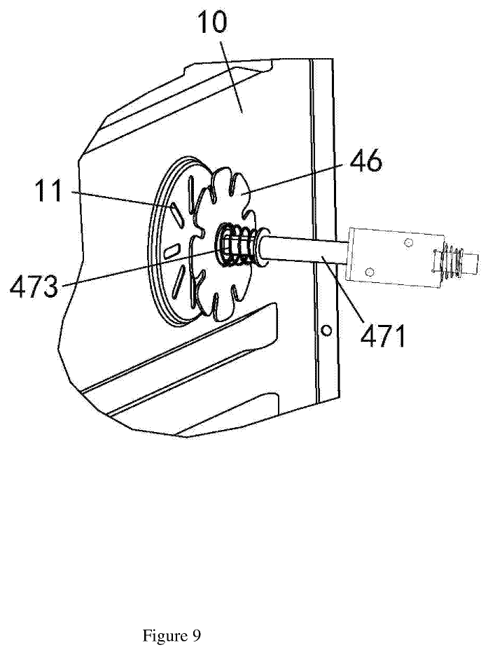

As shown in FIGS. 8 and 9, one end of the driving rod 471 is rotatably arranged on the oven body 10, and the other end of the driving rod 471 is rotatably arranged on the lower smoke-exhausting pipe 41. A sealing ring is arranged at the position where the driving rod 471 is in contact with the lower smoke-exhausting pipe 41. The two ends of the driving rod 471 are installed by adopting a rotatable structure. Meanwhile, by means of the sealing ring arranged on the driving rod 471, the rotatable structure of the driving rod 471 can be more stable, achieving a better sealing effect between the driving rod 471 and the smoke-exhausting pipes. Thus, the smoke can be prevented from being leaked. Additionally, an elastic element 473 is arranged between the driving rod 471 and the sealing element 46, and the elastic element 473 is used for pressing the sealing element 46 on the exhausting holes 11. Through the elastic force imposed on the sealing element 46 by the elastic element 473, the sealing element 46 can be tightly attached to the exhausting holes 11. In this way, the exhausting holes 11 can be better sealed by the sealing element 46.

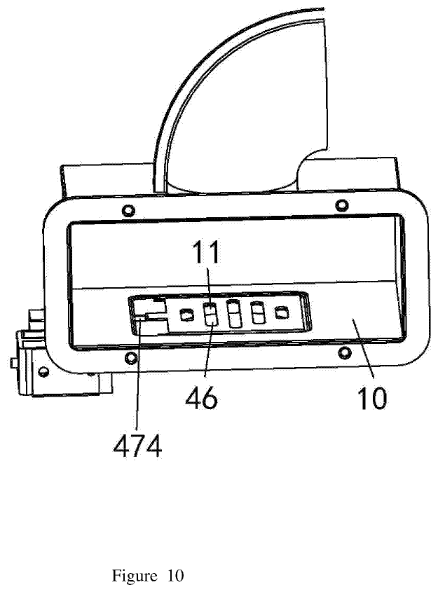

As shown in FIG. 10, a plurality of linearly-distributed exhausting holes 11 are formed in the side wall of the oven body 10, and a plurality of linearly-distributed sealing blades are arranged on the sealing element 46. The aforesaid is the second structure for achieving the interaction between the sealing element 46 and the exhausting holes 11. The driving element 47 is used for driving the sealing element 46 to linearly reciprocate, enabling the sealing element 46 to reciprocate between the staggered position and the overlapped position. Thus, the opening and closing of the exhausting holes 11 can be achieved. Through the one-to-one interaction between the plurality of linearly-distributed sealing blades of the sealing element 46 and the plurality of linearly-distributed exhausting holes 11, the positions of the sealing blades can be switched during the moving process. When the positions of the sealing blades and the exhausting holes 11 are staggered, the exhausting holes 11 are opened, and when the positions of the sealing blades and the exhausting holes 11 are overlapped, the exhausting holes 11 are blocked by the sealing blades. The exhausting efficiency can be improved in the opening state. When the exhausting holes need to be sealed, the sealing element 46 can be moved for a small distance and the exhausting holes can be sealed. The structure of the sealing valve is simple and reliable, achieving a better sealing effect. Furthermore, a stopping block 474 is arranged on the driving element 47, and a touch switch is arranged at the position corresponding to the stopping block 474. The touch switch is connected to the driving element 47 for controlling the reversing of the driving element 47. Through the interaction between the stopping block 474 on the driving element and the touch switch, the driving element 47 can be automatically reversed. Thus, when being driven, the moving direction of the sealing element 46 is more accurate, and a correct state-switching of the sealing element 46 can be ensured.

According to the smokeless oven with a smoking function of the present invention, during use, the food can be placed on a grille inside the oven body 10, the smoking box 20 is located at the bottom in the oven body 10, and meanwhile, the smoking box 20 is located under the food. When the fuel in the smoking box 20 is in a half-combustion state, the generated smoke rises in the oven body 10, thereby smoke-curing the food located above. During the smoking process, the air-introducing fan 33 of the air-introducing assembly 30 can be automatically controlled through the control system of the oven. Thus, the external fresh air can be sucked in and blown into the oven body 10 through the air guide cover 32. Specifically, when the air-introducing fan 33 is initiated, a wind power can be generated, thereby blowing the air shield 34 upwards. Thus, the air shield 34 can be turned over and lifted, and the passage in the air-introducing assembly 30 can be opened, allowing the air sucked in by the air-introducing fan 33 to be blown into the oven body 10 through the air guide cover 32. As the outlet of the air-introducing assembly 30 faces the smoking box 20, the air blown into the oven body can be directly supplied to the smoking box 20, not only preventing the fuel from being extinguished due to the lack of oxygen, but avoiding an open flame from occurring. Thus, the fuel in the smoking box 20 can be always kept in a half-combustion state so that more smoke can be produced for better smoking the food. If the fresh air does not need to be sucked in, the air-introducing fan 33 isn't initiated, enabling the air shield 34 to be automatically turned over and drop. Thus, the internal passage of the air-introducing assembly 30 can be closed. In this way, the smoke in the oven body 10 can be prevented from being leaked. The smoke is blocked in the oven body 10, and thus the oven body 10 is full of high-temperature smoke, achieving a better smoking effect.

When the smoke in the oven body is excessive, a part of the smoke needs to be exhausted. At this point, the smoke-exhausting fan 43 of the smoke-exhausting assembly 40 is controlled by the control system of the oven to suck out the smoke in the oven body 10. The smoke sucked out is exhausted to the outside through the lower smoke-exhausting pipe 41 and the upper smoke-exhausting pipe 42. Specifically, the propelling device 45 propels the sealing plate 44 to move in advance to open the internal passage of the smoke-exhausting assembly 40, and meanwhile, the sealing element 46 is staggered from the exhausting holes 11 under the driving of the driving element 47. Thus, the exhausting holes 11 are opened, and a sucking force is generated during the operation of the smoke-exhausting fan 43, thereby producing a negative pressure between the lower smoke-exhausting pipe 41 and the upper smoke-exhausting pipe 42. As a result, the smoke in the oven body 10 can be sucked into the lower smoke-exhausting pipe 41, and then enter the filter box 51. After being filtered by the filter 50 arranged in the filter box 51, the filtered smoke enters the upper smoke-exhausting pipe 42 and is exhausted to the outside. Before being exhausted, the pollutants in the smoke are removed. If the smoke does not need to be exhausted, the smoke-exhausting fan 43 isn't initiated, and the propelling device 45 propels the sealing plate 44 to move reversely, enabling the internal passage of the smoke-exhausting assembly 40 to be closed by the sealing plate 44. Meanwhile, the exhausting holes 11 are sealed by the sealing element under the driving of the driving element 47, thus preventing the leakage of the smoke in the oven body 10. In this way, the smoke can be completely blocked in the oven body 10. According to the present invention, during the process of smoke-curing food, the production of the smoke can be controlled, and the smoke can be prevented from being directly exhausted to the environment, achieving a safe and eco-friendly use.

The above description is only the preferred embodiments of the present invention and does not limit the patent scope of the present invention, any equivalent structure or equivalent process modification used according to the contents of the specification and accompanying drawings in the present invention, no matter whether it is directly or indirectly used in any other related technical field, should be included within the protection scope of the present invention.

1. A smokeless oven with a smoking function, comprising:
an oven body, wherein a smoking box is arranged in the oven body, and the body walls of the oven body are provided with an air-introducing assembly and a smoke-exhausting assembly, wherein both the air-introducing assembly and the smoke-exhausting assembly are communicated with the exterior and interior of the oven body, wherein a filter is arranged in the smoke-exhausting assembly.

2. The smokeless oven with a smoking function of claim 1, wherein the smoking box is located on the bottom surface of the interior of the oven body, and the air-introducing assembly and the smoke-exhausting assembly are respectively arranged on opposite side walls of the oven body.

3. The smokeless oven with a smoking function of claim 2, wherein the smoking box comprises a box body and a box cover, and the box cover is detachably connected to the box body through a rotary buckle structure.

4. The smokeless oven with a smoking function of claim 1, wherein the air-introducing assembly comprises an air-introducing plate, an air guide cover and an air-introducing fan, wherein an air inlet is formed in the air-introducing plate, and the air-introducing plate is fixedly arranged on the outer side surface of the oven body, wherein the air inlet is communicated with an opening in the oven body, wherein the air guide cover and the air-introducing fan are respectively arranged on the air-introducing plate, wherein the air-in end of the air guide cover is connected to an outlet of the air-introducing fan, and the air-out end of the air guide cover covers the air inlet of the air-introducing plate.

5. The smokeless oven with a smoking function of claim 4, wherein the air guide cover is internally provided with an air shield for sealing or opening the air-in end of the air guide cover, wherein one side of the air shield is rotatably connected to the air guide cover through a rotating shaft, thereby enabling the other side of the air shield to be turned over.

6. The smokeless oven with a smoking function of claim 1, wherein the smoke-exhausting assembly comprises a lower smoke-exhausting pipe and an upper smoke-exhausting pipe, wherein the lower smoke-exhausting pipe and the upper smoke-exhausting pipe are respectively connected with the two sides of the filter, wherein the lower smoke-exhausting pipe is communicated with the opening in the side wall of the oven body.

7. The smokeless oven with a smoking function of claim 6, wherein a smoke-exhausting fan is arranged in the upper smoke-exhausting pipe.

8. The smokeless oven with a smoking function of claim 6, wherein a sealing plate is arranged between the lower smoke-exhausting pipe and the filter, and a propelling device is connected to the sealing plate, wherein the propelling device is used for propelling the sealing plate to reciprocate, thereby sealing or opening the passage between the lower smoke-exhausting pipe and the filter.

9. The smokeless oven with a smoking function of claim 6, wherein the filter comprises a filter box, a filter element and a cover, wherein one side of the filter box is provided with an opening, wherein the cover is rotatably connected to one side of the filter box provided with the opening in a rotatable opening and closing manner through a rotating shaft, wherein the filter element can be freely inserted into or pulled out of the filter box from the opening of the filter box.

10. The smokeless oven with a smoking function of claim 9, wherein the two sides of the filter box are respectively provided with an upper connecting hole and a lower connecting hole, wherein the upper connecting hole is connected to the upper smoke-exhausting pipe, and the lower connecting hole is connected to the lower smoke-exhausting pipe.

11. The smokeless oven with a smoking function of claim 10, wherein the two sides of the filter element are respectively provided with an upper air hole and a lower air hole, wherein the upper air hole corresponds to the upper connecting hole, and the lower air hole corresponds to the lower connecting hole, wherein the periphery of the upper air hole and the periphery of the lower air hole are respectively provided with a sealing ring, wherein the sealing rings on the peripheries of the upper air hole and the lower air hole are respectively clamped with the inner wall surfaces of the upper connecting hole and the lower connecting hole.

12. The smokeless oven with a smoking function of claim 9, wherein the cover comprises a pressing plate and a covering plate, wherein the pressing plate is fixedly mounted on one side of the opening of the filter box, and the pressing plate surrounds the periphery of the opening of the filter box, wherein the covering plate is connected to the filter box in a rotatable opening and closing manner through a rotating shaft.

13. The smokeless oven with a smoking function of claim 12, wherein an elastic locker is arranged on the pressing plate, and a locking hook is arranged on the covering plate, wherein the locking hook interacts with the elastic locker, thereby enabling the covering plate and the pressing plate to be locked or unlocked.

14. The smokeless oven with a smoking function of claim 6, wherein a sealing element and a driving element are arranged in the lower smoke-exhausting pipe, wherein the driving element is used for driving the sealing element to move, thus enabling the sealing element to open or close the opening communicated with the lower smoke-exhausting pipe in the side wall of the oven body.

15. The smokeless oven with a smoking function of claim 14, wherein a plurality of exhausting holes distributed in a circumferential array are formed in the side wall of the oven body, and the exhausting holes are communicated with the lower smoke-exhausting pipe, wherein the sealing element comprises a plurality of sealing blades arranged in a circumferential array, wherein the driving element comprises a driving rod and a driver, and the driving rod is rotatably arranged on the oven body, wherein the sealing element is fixed on the driving rod and is attached to the exhausting holes, wherein the driver is used for driving the driving rod to rotate, thereby enabling the sealing blades to rotate relative to the exhausting holes, wherein the positions of the sealing blades and the exhausting holes can be staggered or overlapped, allowing the exhausting holes to be opened or closed by the sealing blades.

16. The smokeless oven with a smoking function of claim 15, wherein one end of the driving rod is rotatably arranged on the oven body, and the other end of the driving rod is rotatably arranged on the lower smoke-exhausting pipe, wherein a sealing ring is arranged at the position where the driving rod is in contact with the lower smoke-exhausting pipe.

17. The smokeless oven with a smoking function of claim 16, wherein an elastic element is arranged between the driving rod and the sealing element, and the elastic element is used for pressing the sealing element on the exhausting holes.

18. The smokeless oven with a smoking function of claim 14, wherein a plurality of linearly-distributed exhausting holes are formed in the side wall of the oven body, and a plurality of linearly-distributed sealing blades are arranged on the sealing element, wherein the driving element is used for driving the sealing element to linearly reciprocate, enabling the sealing element to reciprocate between the staggered position and the overlapped position.

19. The smokeless oven with a smoking function of claim 18, wherein a stopping block is arranged on the driving element, and a touch switch is arranged at the position corresponding to the stopping block, wherein the touch switch is connected to the driving element for controlling the reversing of the driving element.
